(19) United States
(12) Patent Application Publication
(10) Pub. No.: US 2018/0350145 A1
(43) Pub. Date: Dec. 6, 2018

(54) Augmented Reality Devices and Methods Thereof for Rendering Virtual Objects

(71) Applicant: Reston Restoration, Reston, VA (US)

(72) Inventors: Maarten Byl, Reston, VA (US); Justin Aukamp, Herndon, VA (US)

(73) Assignee: Reston Restoration, Reston, VA (US)

(21) Appl. No.: 15/609,005

(22) Filed: May 30, 2017

(51) Int. Cl. G06T 19/00; G06T 19/20

(52) U.S. Cl. CPC G06T 19/006; G06F 3/017; G06T 2219/2004; G06T 19/20

(57) ABSTRACT

A method of rendering virtual objects within a real physical space is disclosed. The method includes capturing, by an augmented reality device, spatial information associated with the real physical space; defining, by the augmented reality device, an anchoring point and an anchoring vector for placing a virtual object within the real physical space based on the spatial information; and overlaying, by the augmented reality device, the virtual object on the anchoring point along the anchoring vector, wherein overlaying comprises: matching a predefined point in the virtual object with the coordinates of the anchoring point; and aligning a predefined facet of the virtual object with the anchoring vector.

### BACKGROUND

This disclosure relates generally to augmented reality devices, and more particularly to augmented reality devices and methods thereof for rendering virtual objects to appear to a viewer in real physical space.

Augmented reality devices can be used nowadays in diverse fields that may include, gaming, medical procedures, construction, design and architecture, and education. Augmented reality devices immerse a user in a mixed reality or augmented reality environment using virtual objects (three-dimensional (“3D”) holograms, two-dimensional (“2D”) holograms, etc.) that can be viewed as if they are within, or restricted by, real physical space. As a result, a user is able to experience real world scenarios without actual execution of these scenarios in the real world. This is not only a cost effective approach for many situations and applications, but also enables a user to have an interactive experience within a real-world room or structure, or any indoor or outdoor area of interest.

### SUMMARY

In design or construction of any project, the final constructed or as-built project cannot be viewed before the project is completed. The professional or contractor performing the construction or design is limited to showing the customer representations of the as-built project using plans, designs, blueprints, drawings, physical or virtual models, and/or simulations. Virtual reality devices can provide the user views of the plans, designs, blueprints, drawings, physical or virtual models, and/or simulations. However, the user's views in a virtual reality device remain within virtual simulation of the project, which is driven completely by software.

For example, when an augmented reality device is used for design or construction projects, placement of virtual objects, such as 3D holograms, to appear as if the virtual objects are within an area of physical space is rarely accurate to a point in the physical space. Further, the user cannot interact with these virtual objects in such a way to allow for a more precise placement of virtual objects in physical space, in real-time.

It may therefore be beneficial to provide augmented reality devices and methods thereof for rendering virtual objects that can be viewed and manipulated by the user as if the virtual objects are within real physical space. It may be further beneficial to provide methods and systems that can enable a user to interact with virtual objects such as 3D holograms, via the augmented reality device and supporting software, such that these virtual objects can be overlaid and anchored within real physical space in the desired areas.

In one embodiment, a method of rendering virtual objects within a real physical space is disclosed. The method includes capturing, by an augmented reality device, spatial information associated with the real physical space; defining, by the augmented reality device, an anchoring point and an anchoring vector for placing a virtual object within the real physical space based on the spatial information; and overlaying, by the augmented reality device, the virtual object on the anchoring point along the anchoring vector, wherein overlaying comprises: matching a predefined point in the virtual object with the coordinates of the anchoring point; and aligning a predefined facet of the virtual object with the anchoring vector.

In another embodiment, an augmented reality device is disclosed. The augmented reality device comprises: a processor, a plurality of sensors communicatively coupled to the processor; a display communicatively coupled to the processor; and a memory communicatively coupled to the processor, wherein the memory stores processor instructions, which, on execution, causes the processor to: capture, via at least one of the plurality of sensors, spatial information associated with the real physical space; define, via at least one of the plurality of sensors, an anchoring point and an anchoring vector for placing a virtual object within the real physical space based on the spatial information; and overlay, via the display, the virtual object on the anchoring point along the anchoring vector, wherein the processor overlays the virtual object by: matching, via at least one of the plurality of sensors, a predefined point in the virtual object with the coordinates of the anchoring point; and aligning, via at least one of the plurality of sensors, a predefined facet of the virtual object with the anchoring vector.

In yet another embodiment, a non-transitory computer-readable storage medium having stored thereon, a set of computer-executable instructions for rendering virtual objects within a real physical space is disclosed. The set of computer-executable instructions cause a computer comprising one or more processors to perform steps comprising: capturing, by an augmented reality device, spatial information associated with the real physical space; defining, by the augmented reality device, an anchoring point and an anchoring vector for placing a virtual object within the real physical space based on the spatial information; and overlaying, by the augmented reality device, the virtual object on the anchoring point along the anchoring vector, wherein overlaying comprises: matching a predefined point in the virtual object with the coordinates of the anchoring point; and aligning a predefined facet of the virtual object with the anchoring vector.

In the embodiments, both the foregoing general description and the following detailed description are exemplary and explanatory only and are not restrictive of the invention, as claimed.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 illustrates an environment 100 (that is exemplary) in which various embodiments may function.

FIG. 2 illustrates a block diagram of various elements within an augmented reality device, in accordance with an embodiment.

FIG. 3 illustrates a flowchart of a method for rendering virtual objects in a real physical space, in accordance with an embodiment.

FIGS. 5-12 illustrate a user's interaction with 3D hologram of a kitchen cabinet via an augmented reality device to move the 3D hologram for its precise placement within a room, in accordance with an exemplary embodiment.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Like numbers refer to like elements or steps throughout, and prime notation is used to indicate similar elements or steps in alternative embodiments. The flow chart blocks in the figures and the description depict logical steps and/or reason code from a reason code module to operate a processor, computer system, controller, compounding system, etc. to perform logical operations and control hardware components and devices of the embodiments using any appropriate software or hardware programming language. In one embodiment, object code in a processor can generate reason codes during execution of the associated logical blocks or steps.

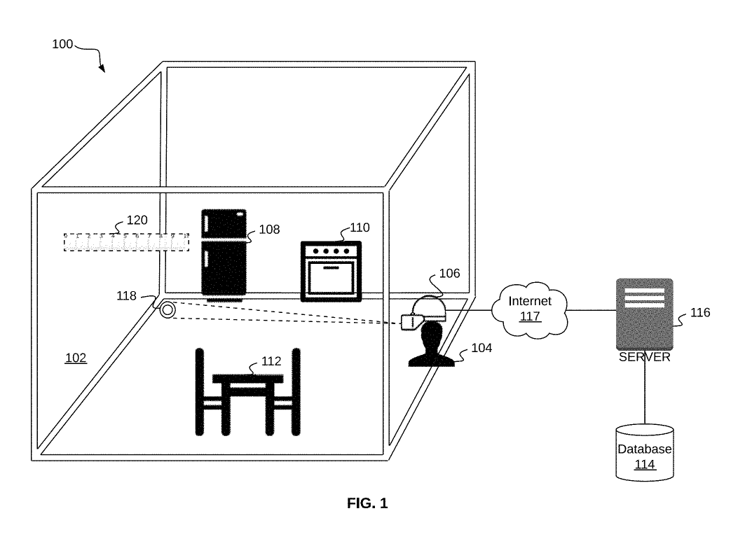

Referring to FIG. 1, an exemplary environment 100 in which various embodiments may function, is illustrated. In other embodiments, environment 100 could be any indoor or outdoor facility, structure, scene, or area. Environment 100 can include a room 102 in real physical space. The environment 100 can represent a room in which placement or fitment of articles (for example, furniture, lighting, or appliances) or any modification in its layout is required. Furthermore, it will be apparent to a person skilled in the art that room 102 in the environment 100 may be replaced by any real physical space that requires any enhancement or modification. Examples of the real physical space may include, but are not limited to, an open space for installation of permanent or temporary structures (for example, for an exhibition, a ceremony, a conference, or any other event), a vehicle (for example, a car, a private plane, a recreational vehicle), an outdoor area within which a construction project is to be implemented, a bare shell in a building, or a design of an article(s) the requires placement of discreet portions or sub-assemblies of or for the article(s).

In another example, to determine whether a particular article would suit interiors of the room 102 or whether any modification inside room 102 would create an acceptable design, a user 104 would have to first purchase the article or actually execute such modifications. This would not only be a cost and time intensive exercise, but after placement of the article or completion of modifications, the user 104 might not even be satisfied with the end results. By way of an example, the user 104 desires to build a kitchen in the room 102 and may have envisioned certain designs based on articles selected from various catalogues of kitchen related articles, structures, and/or amenities. However, images in catalogues are merely representative of the actual articles, structures, and/or amenities, and illustrated either alone or within another room or structure that is not the room 102. The final kitchen that would be constructed in room 102 based on these catalog images might turn out not to fit within the dimensions of the room 102, could have components that need to be resized or re-oriented, or could be subjectively rejected by the user 104 simply because he or she may not be pleased with the as-built design.

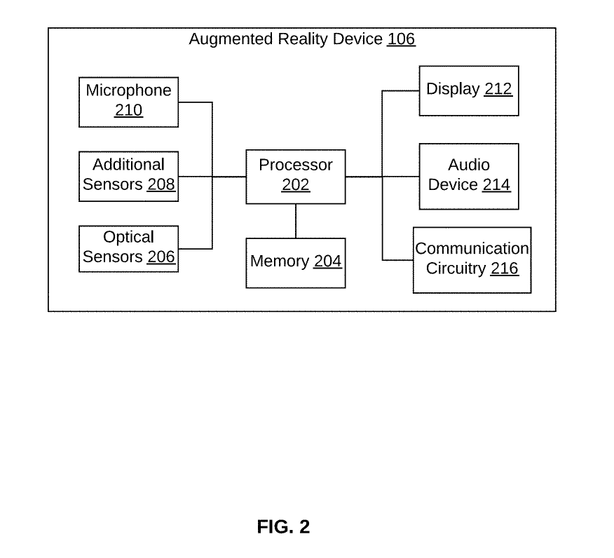

It may be also be desirable to enhance the user's 104 experience, therefore, such that the user 104 can utilize an augmented reality device 106 to view the room 102 in a mixed reality environment. The augmented reality device 106 may be mountable on user 104's head, which allows the user 104 to view both virtual objects and the room 102 simultaneously. It will be apparent to a person skilled in the art that augmented reality device 106 may also be any augmented reality device that performs and accomplishes the functions described herein. Examples of the augmented reality device 106 can include any mixed reality viewing platforms such as but not limited to the Microsoft HoloLens and Magic Leap. In the various embodiments, any augmented reality device that could perform the methods and functions of embodiment is intended to be encompassed by the scope of the claims. In other embodiments, the augmented reality device 106 can be enhanced to perform the various embodiments of the inventions. The augmented reality device 106 is explained in further detail in conjunction with FIG. 2.

FIG. 2 illustrates a block diagram of various elements within the augmented reality device 106, in accordance with an embodiment. The augmented reality device 106 may include a head gear (not shown in FIG. 2) that can cooperate with the head of user 104 to keep augmented reality device 106 secure when worn by user 104.

Augmented reality device 106 may include a processor 202 communicatively coupled to a memory 204. Control logic (in this example, software instructions or computer program code), when executed by the processor 202, causes processor 202 to perform the functions of the embodiments as described herein. Memory 204 may be a non-volatile memory or a volatile memory. Examples of non-volatile memory, may include, but are not limited to a flash memory, a Read Only Memory (ROM), a Programmable ROM (PROM), Erasable PROM (EPROM), and Electrically EPROM (EEPROM) memory. Examples of volatile memory may include, but are not limited Dynamic Random Access Memory (DRAM), and Static Random-Access memory (SRAM). Systems and methods may include different combinations of the foregoing, whereby different portions of the instructions and data are stored on different types of media.

The processor 202 may be any known, related art or later developed processor. Alternatively, the processor may be a dedicated device, such as an ASIC (application-specific integrated circuit), DSP (digital signal processor), or any type of processing engine, circuitry, etc. in hardware or software. Although FIG. 2 illustrates the processor 202, memory 204, and other elements of the augmented reality device 106 as being within the same block, it will be understood by those of ordinary skill in the art that the processor 202 and memory 204 may actually include multiple processors and memories that may or may not be stored within the same physical housing. For example, processor 202 or memory 204 may be located in a housing or computer that is different from that of augmented reality device 106. Accordingly, references to a processor, augmented reality device, or computer will be understood to include references to a collection of processors, computers or memories that may or may not operate in parallel. Rather than using a single processor to perform the steps described herein, some of the components may each have their own processor and/or memory that only performs calculations and/or instructions related to the component's specific function.

In an alternative embodiment, the processor 202 may be located remote from the augmented reality device 106 and communicate with the augmented reality device 106 wirelessly. In the embodiments, some of the processes described herein can be executed on a processor disposed within the augmented reality device 106, and others by a remote processor on a remote server.

The memory 204 can store information accessible by the processor 202 including instructions and data that may be executed or otherwise used by the processor 202. In an embodiment, the memory 204 may store a database of the virtual objects or models that user 104 may select from, for example virtual objects or models for being viewed within a real physical space.

The instructions may be any set of instructions to be executed directly (such as machine code) or indirectly (such as scripts) by the processor 202. For example, the instructions may be stored as computer code on the computer-readable medium. In this regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

Data may be retrieved, stored or modified by the processor 202 in accordance with the instructions. For instance, although the system is not limited by any particular data structure, the data may be stored in computer registers, in a relational database as a table having a plurality of different fields and records, XML documents or flat files. The data may also be formatted in any computer-readable format. The data may include any information sufficient to identify the relevant information, such as numbers, descriptive text, proprietary codes, references to data stored in other areas of the same memory or different memories (including other network locations) or information that is used by a function to calculate the relevant data.

In an embodiment, the processor 202 can be communicatively coupled to optical sensors 206, which can be disposed at different locations within augmented reality device 106, such that the optical sensors 206 can capture information related to the real physical space and real physical objects that user 104 would be able to view through augmented reality device 106. This information, for example, may include dimensions of real physical objects and depth information related to the real physical space. In some embodiments, the optical sensors 206 can also capture the user's 104 gestures, gaze, head movement, point of interest, reaction (based on dilation of pupils) on seeing an object through augmented reality device 106. Examples of optical sensors 206 may include, but are not limited to, a depth camera, an infrared light camera, a visible light camera, a position tracking camera, and an eye-tracking sensor.

In addition to inputs received from optical sensors 206, processor 202 can receive inputs from additional sensors 208 and can analyze these inputs in order to enable augmented realty device 106 to perform a desired operation. Examples of additional sensors 208 may include, but are not limited to, a 3D inclinometer sensor, accelerometer, gyroscope, pressure sensor, heat sensor, ambient light sensor, a compass, variometer, a tactile sensor, a Global Positioning System (GPS) sensor, etc. By way of an example, a gyroscope and/or an accelerometer may be used to detect movement of augmented reality device 106 mounted on user's 104 head. This movement detection along with an input received from an eye-tracking sensor and a depth camera would enable processor 202 to precisely identify user 104's point of interest in the real physical space.

User 104 may also provide voice commands through a microphone 210 that is communicatively coupled to processor 202. Based on inputs received from one or more of optical sensors 206, additional sensors 208, and/or microphone 210, processor 202 can execute instructions of pre-stored computations on these inputs to determine an output to be rendered on a display 212 and/or an audio device 214. Display 212 is a transparent display that not only enables user 104 to see real physical objects and real physical space through display 212, but also can display holograms and other virtual objects for user 104 to view. As a result, user 104 can visualize a hologram within the real physical space through display 212. By way of an example, when user's 104 point of interest in the real physical space has been identified by processor 202 (based on inputs received from optical sensors 206 and additional sensors 208) display 212 displays cursor 118 to the user 104, such that cursor 118 mimics a point in space aligned with a forward gaze of user 104. In addition to visual rendering on display 212, processor 202 can also generate audio outputs through audio device 214. Audio device 214, for example, may include one or more speakers, integrated earphones, or an audio jack that may be connected to external earphones. Simultaneous rendering of video/audio outputs and enabling user 104 to interact with the virtual objects or Holograms rendered on display 212, completely immerses user 104 in a mixed reality environment.

Augmented reality device 106 can include a communication circuitry 216 that is coupled to processor 202. Communication circuitry 216 can enable communication of augmented reality device 106 with external computing devices and the Internet 117. Examples of these external computing devices may include, but are not limited to a mobile device, a desktop computer, a smart phone, a tablet computer, a phablet computer, a laptop computer, a gaming device, a set-top box, a smart TV, or any storage device that has communication capability. Communication circuitry 216 can use various wired or wireless communication protocols to communicate with external computing devices. Examples of these communication protocols include, but are not limited to, Bluetooth, Wi-Fi, Zigbee, Infrared, NearBytes, and Near Field Communication (NFC).

The augmented reality device 106 can enable the user 104 to select virtual objects or models associated with articles and/or the structural modifications and then visualize their placement within the room 102, by virtually inserting these virtual objects or models within the room 102 and using commands instructed by the user 104. In one embodiment, a refrigerator 108, an oven 110, and a dining table 112 are depicted as virtual objects that can be commanded to be overlaid within the room 102 by user 104. These virtual objects or models may be holograms that are created using a hologram modeling software platform.

Any virtual objects or models, including the refrigerator 108, the oven 110, and the dining table 112, can be stored in a database 114 and may be created based on specific requirements placed by user 104, manufacture's specifications, or any other specifications. The database 114 may also include floor plans, dimensions, and layout information associated with room 102. For example, in response to the user's 104 request, the augmented reality device 106 may connect with the Internet 117 to extract these virtual objects or models from the database 114 through a server 116. In an alternative embodiment, the augmented reality device 106 may communicate with a mobile device (not shown in FIG. 1) of user 104 to retrieve these virtual objects or models. Alternatively, augmented reality device 106 may store virtual objects or models in the memory 204 or processor 202.

In an embodiment, in addition to overlaying these virtual objects in room 102, augmented reality device 106 can enable the user 104 to interact with virtual objects in order to change the virtual objects' location within room 102. In other embodiments, augmented reality device 106 can enable the user 104 to interact with virtual objects in order to modify their dimensions and orientations. In the embodiments, augmented reality device 106 can display a cursor 118 on its display 212, such that, cursor 118 mimics a point in space that follows the movement of the augmented reality device 106. As a result, user 104 is able to determine if he is accurately observing a point of interest in room 102. Based on this, user 104 may perform desired actions on virtual objects overlaid within room 102.

In an embodiment, the user 104 may be able to place the holographic dining table 112 into the user's view of the room 102 by moving the augmented reality device 106, thus moving the cursor 118, over dining table 112, activate a move command from the processor 202, and thereafter move dining table 112 to determine whether it would fit within the space available between refrigerator 108 and oven 110. Thus, without actually purchasing a real refrigerator, oven, or a dining table, user 104, via augmented reality device 106 is able to determine how these objects would look and fit within the dimensions of the floorplan of room 102. Once user 104 is satisfied with the current placement of virtual objects within room 102, user 104 may activate a menu from instructions in processor 202 and store the current layout configuration in memory 204 as a configuration that the user 104 desires to be implemented in the real world.

To aid the user's 104 interaction with the virtual objects and to enable precise overlaying of the virtual objects within the room 102, the augmented reality device 106 may display a virtual ruler 120 in response to a command received from the user 102, via processor 202. The request may be in the form of a gesture made by the user 104 or a predefined voice command, for example, “Open Ruler.” The virtual ruler 120 may be used to measure and compare dimensions of the virtual objects and dimension of the real physical space on which the virtual objects is overlaid. By using the virtual ruler 120, the user 104 is able to determine in real time whether the current dimensions of a particular virtual object are too large or small to be precisely overlaid in a desired area within the real physical space. The virtual ruler 120 thus aids in precise placement of the virtual objects. By way of an example, with help of the virtual ruler 120, the user 104 may be able to determine the desirable dimensions of the refrigerator 108 and the oven 110 to be aesthetically placed within the confines of the room 102, based on a comparison with dimensions of the room 102. Moreover, the user 104 will also be able to determine dimensions of the dining table 112 that would fit within the space available between the refrigerator 108 and the oven 110.

In an embodiment, the user 104 may invoke multiple such virtual rulers 120, in order to measure dimensions of multiple objects simultaneously. The user 104 may also be provided with an option to record a measurement made by the virtual ruler 120 and tag it with an object (virtual or real) for which the measurement was made, based on processor instructions in processor 202. This recorded data may be used by the user 120 while designing or manufacturing real objects. In another embodiment, the user 104 may be provided options to change the measuring scale and design of the virtual ruler 120. Additionally, the user 104 may be able to interact with the virtual ruler 120 in order to contract or expand the virtual ruler 120, place the virtual ruler 120 directly over a virtual object, bend the virtual ruler 120 at multiple points in order to measure an object (real or virtual) that does not have flat dimensions, overlay the virtual ruler 120 within a particular area in the real physical space, or change the orientation of the virtual ruler 120.

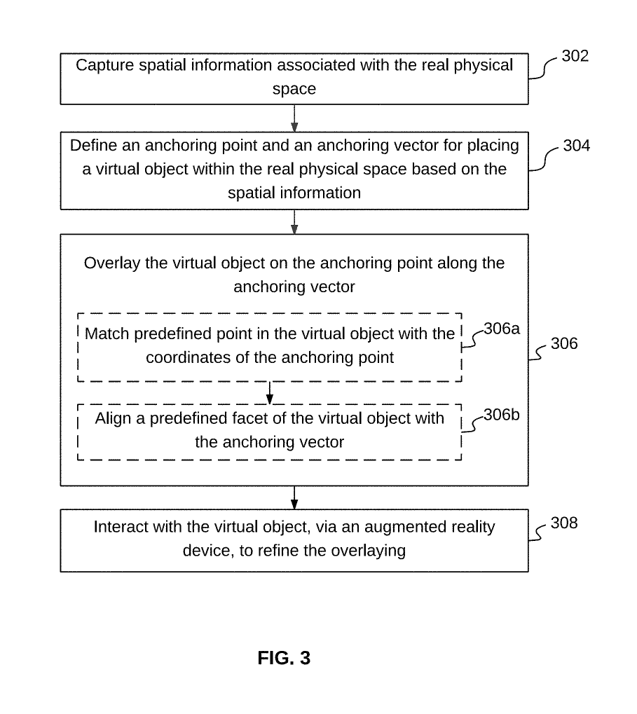

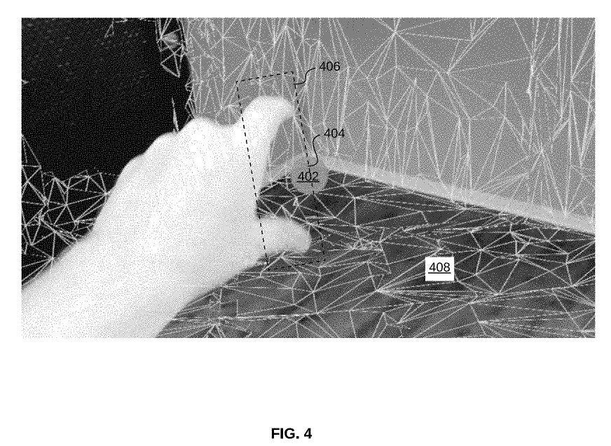

Referring now to FIG. 3, a flowchart of a method for rendering virtual objects within real physical space and interacting with these virtual objects is illustrated, in accordance with an embodiment. The real physical space, for example, may include, but is not limited to an open space for installation of permanent or temporary structures (for example, a home, an office, a building, an exhibition, a ceremony, a conference, etc.), a vehicle (for example, a car, a plane, a recreational vehicle, etc.), or a bare shell in a building. In order to accurately overlay virtual objects or models within the real physical space, augmented reality device 106 can capture spatial information associated with the real physical space using optical sensors 206 and additional sensors 208, at step 302.

Such spatial information, for example, may include depths in the real physical space, location and dimensions of walls or other permanent physical structures, contours of the permanent physical structures, and locations of specific points or corners within the real physical space. Additionally, the spatial information may also be captured using layout information and floor plans associated with the real physical space. These layout plans may be pre-stored in memory 204 of augmented reality device 106 or in database 114.

In an alternative embodiment, before overlaying and viewing the virtual objects within the real physical space, user 104 may be provided with an option to manually select a relevant layout plan via display 212 of augmented reality device 106. This option may be provided by way of a list of layout plans, in response to user 104's voice command, gesture, activation of a button on augmented reality device 106, or any combination thereof. In an embodiment, this option may be provided via instructions of a software application installed in augmented reality device 106.

Alternatively, based on user 104's location, augmented reality device 106 may automatically select the relevant layout plan or display a list of relevant layout plans to user 104, via display 212. In this case, the user's 104 location may be tracked using a GPS sensor built in augmented reality device 106, a mobile device carried by user 104, or other device which is in communication with augmented reality device 106.

Once spatial information of the real physical space has been captured, user 104, via augmented reality device 106, can select the virtual objects from a menu that the user can overlay in the real physical space. In some embodiments, these virtual objects may be 3D holograms that are created by first making 3D images in digital files from 2D images using a software conversion tool. An example of such software conversion tool can include 3ds MAX software. The 3D image file(s) can then be imported into the cross-platform 220 on PC/Server 218. In alternative embodiments, exemplary 3D files may be created using software tools such as, Blender, Autodesk Maya, Cinema 4D, 123D, and Art of Illusion, or any tool that can create 3D images that can accomplish the functions of the embodiments. For example, the Unity platform can read 3D modeling files.fbx, .dae (Collada), .3ds, .dxf, and .skp created in other platforms.

The 3D digital files of objects and articles can be created based on dimensions of real objects and articles such that all virtual objects and articles are made at a 1:1 scale. In one embodiment, the room 102 may be planned to be built out as a kitchen, and the outer dimensions of room 102 is already known. In this case, 3D images of kitchen cabinets, countertops, appliances, and furniture that the user 104 plans to place in the kitchen are first created on a 1:1 scale, such that the those objects are of the same dimensions as the real kitchen cabinets, countertops, appliances, furniture, etc. the user 104 intends to install. These 3D images are then imported into the platform 220 to create 3D holograms.

The 3D holograms thus created may include multiple objects, which can be separated individually from the 3D hologram to act as separate 3D holograms. In an embodiment, a kitchen 3D hologram model may include cabinets 109, refrigerator 108, furniture 112, and oven 110. Each of the cabinets 109, refrigerator 108, furniture 112, and oven 110 may be created as separate 3D holograms, which can be moved independent of each other or grouped and moved together.

In an embodiment, 3D holograms may be pre-created independent of a layout plan of the real physical space. In this case, when the spatial information for the real physical space is being captured in real-time by augmented reality device 106 and the 3D holograms are overlaid in the real physical space thereafter, the 3D holograms may not fit into the dimensions of the room 102 as planned or alternatively may not be the size ultimately desired by the user 104. In the alternative embodiment the user 104 may be able to interact with the 3D holograms in order to resize the 3D hologram for accurate placement. As an example, a user may call a menu tool that can resize an object in one or more dimensions. Then menu tool allows the user to click and drag the object using the user's hand motions in the y axis until the object's size has expanded into a proper fit within the confines of other hologram objects and/or the physical room dimensions in the y direction.

After the spatial information for the real physical space has been captured (either in real-time or based on the pre-stored layout plans) and user 104 has selected the virtual object or group of objects that is to be overlaid in the real physical space, user 104, via the augmented reality device 106, can define an anchoring point and an anchoring vector for placing the virtual object or combined objects within the real physical space, at step 304. Selection of an anchoring point is also depicted in FIG. 4, which illustrates a room 408, a corner 404 of the room 408, an anchor cursor 402 and a hand gesture 406 of the user 104. In an embodiment, after user 104, via augmented reality device 106, has selected the virtual object from a menu, the anchor cursor 402 of a predefined shape can be rendered on display 212 of augmented reality device 106 for the user 104 to view. The user 102 can move the cursor 402 by moving the augmented reality device 106. In the embodiments, the user 104 may be able to customize the shape, size, and/or color of the anchor cursor 402. The anchor cursor 402 has a different function and purpose than cursor 118. The anchor cursor 402 may be a predefined anchor point for a single holographic object or a group of holographic objects, such as all objects viewed within the room 102. Movement of the anchor cursor 402 that appears to the user 102 to be within the real physical space may be controlled by user 104 moving the augmented reality device 106 with head movements similar to moving the cursor 118. In alternative embodiments, the anchor cursor 402 can be moved with a user's gaze, hand gestures, voice commands, or a combination thereof.

To define the anchoring point in step 304 within the real physical space in room 408, user 104 places the anchor cursor 402 over a preselected point in room 408 and performs a hand gesture to lock the cursor onto that preselected point. Locking the cursor defines the anchoring point in the x,y,z coordinates of the room 408. In an embodiment, when user 104 has selected a virtual object to be placed in room 102, to define an anchoring point, user 104 first places the cursor on a corner of room 102 and thereafter the user 104 performs a hand gesture or audio command that the augmented reality device 106 will recognize to lock the cursor on that corner. This is also depicted in FIG. 4, which illustrates that in order to define an anchoring point at a corner 404 of a room, user 104 places a cursor 402 on corner 404 and starts to make a hand gesture 406 of touching his thumb with his index finger to lock cursor 402 on corner 404.

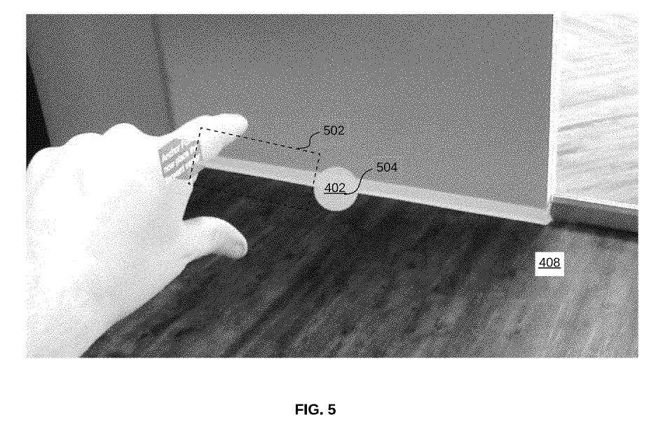

FIG. 5 illustrates an anchoring vector 502 placed by user 104 along one of the edges of the room 408. Anchoring vector 502 connects the anchoring point placed on corner 404 and a subsequent point 504 defined by a subsequent gesture made by user 104. After the anchoring point has been defined, user 104 can move the cursor 402 along a preselected line in the real physical space and to define the anchoring vector 502. The anchoring vector 502 connects the anchoring point and the subsequent point at which the cursor was locked by user 104. In continuation of the example given above, after user 104 has defined the anchoring point, user 104 moves the cursor in a predetermined direction and again gestures to lock the cursor at a subsequent point at the end of the vector. This action results in defining the anchoring vector.

Once both the anchoring point 404 and the anchoring vector 502 have been defined by user 104, augmented reality device 106 can overlay the virtual object on the anchoring point and along the anchoring vector at step 306 using the virtual object's anchor point and anchoring vector. Each virtual object, or group of virtual objects, can have its zero point axis defined at any location on the object. For example, a virtual object can have a back face, sides, and front face. The virtual object can have its zero anchor point defined at a lower back corner and its anchor vector defined as the length of the lower back side. To set the virtual object in the room 408, at step 306a the augmented reality device 106 matches the virtual object's anchor point with the coordinates of the anchoring point 404 and at step 306b, and in step 306b aligns an anchoring vector of the virtual object with the anchoring vector 502 defined for the room 408. The user 104, while creating the virtual object (a 3D hologram, for example) may define an anchor point in that virtual object at any coordinate on the object's axis, such that the augmented reality device 106 would match the virtual object's anchoring point with the anchoring point in the real physical space selected by the user's 104 interaction via the augmented reality device 106.

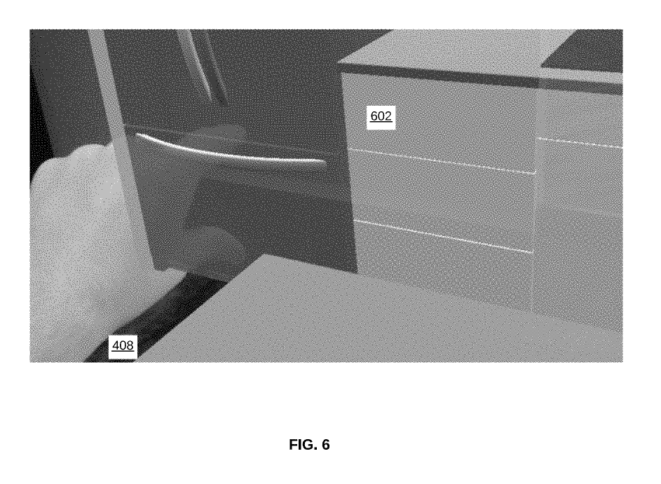

In an embodiment, when user 104 desires to overlay a 3D hologram of fixture in room 102, during creation of the 3D hologram the user 104 can select a lower back corner of the 3D hologram as the object's anchoring point that is to be set to an anchoring point selected within room 102. The user 104 can also select an anchoring vector on the 3D hologram, such as a lower back edge, that can be used to follow an anchoring vector selected in the room 102. After user 104, via augmented reality device 106, has defined the anchoring point and the anchoring vector in the room 102, the augmented reality device 106 overlays the 3D hologram of the virtual object, such that, the lower back corner of the 3D hologram matches with the anchoring point in the room 102, and the 3D hologram's anchoring vector aligned with the anchoring vector in the room 102. If the anchoring point and vector in the room 102 are set in a corner of a floor and along a floor's edge where it meets a wall, respectively, then the 3D hologram will be set onto the floor of the room 408 and the back of the 3D hologram will be set following a wall of the room 408. An exemplary scenario is also depicted by FIG. 6, where a 3D hologram 602 of a grouped appliance, cabinetry, and sink (depicted partially in FIG. 6) is overlaid into room 408, after the anchoring point at corner 404 and anchoring vector 502 have been defined by user 104, via augmented reality device 106.

In many cases, the initial overlaying of a virtual object in the real physical space by augmented reality device 106 may not be precise. In other words, when the virtual object is overlaid after defining the anchoring point and the anchoring vector of a physical space, the predefined anchoring point and vector in the virtual object may not exactly coincide with the desired location viewed in the physical space due to the anchoring point and vector in the real physical space being misplaced. This imprecise initial placement is also depicted in FIG. 6, where 3D hologram 602 of the virtual objects 602 can be seen slightly displaced from the desired area of placement within the room 408.

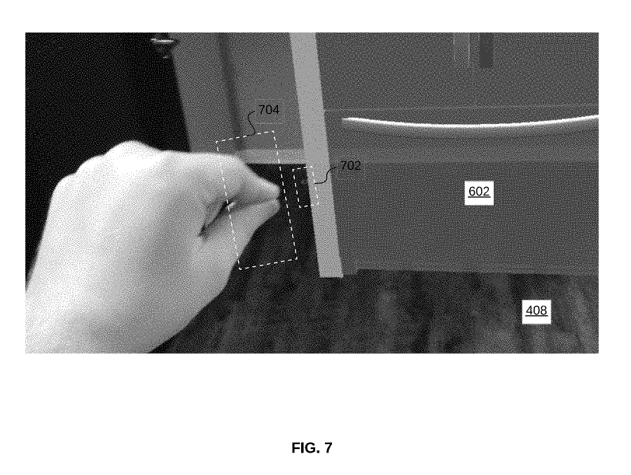

Thus, to refine overlaying of the virtual object 602, user 104 may interact with the virtual object, via augmented reality device 106, at step 308, to exactly match the predefined point of the virtual object 602 with the coordinates of the anchoring point and exactly align the predefined facet of the virtual object with the anchoring vector. User 104's interaction with the virtual object includes either moving the virtual object 602 or altering its dimensions. User 104 may interact with the virtual object 602 through hand gestures, voice commands, gaze, head movement, or a combination thereof. This interaction is depicted in FIGS. 7-12, where user 104 moves 3D hologram 602 of the grouped virtual objects, in order to place it exactly in the desired area within the room 408.

Referring now to FIGS. 7-12, user 104's interaction with 3D hologram 602 of the kitchen cabinet via augmented reality device 106 to move 3D hologram 602 for its precise placement within the room is illustrated, in accordance with an exemplary embodiment. In order to move 3D hologram 602, user 104 may use a voice command, for example, ‘Move Room” or “Shift Room.” Alternatively, user 104 may make a hand gesture to indicate that user 104 wants to move 3D hologram 602. User 104 may also select the option of moving 3D hologram 602 by using a menu built in a software application installed in augmented reality device 106. In response to user 104's activation of interaction with 3D hologram 602, a cursor 702 as depicted in FIG. 7 appears. Cursor 702 may be same as cursor 118 depicted in FIG. 1 or may be custom built for the invention.

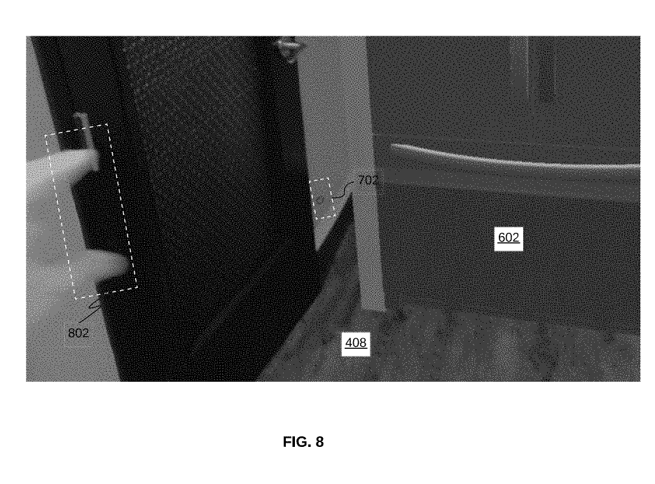

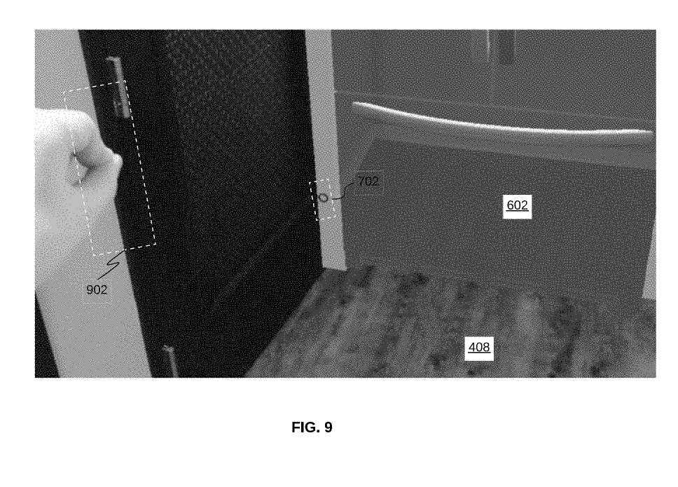

When cursor 702 appears, user 104 joins his index finger and thumb, as shown in 704, to move 3D Hologram 602 in direction of movement of the hand. In FIG. 7, user 104 is pulling 3D hologram 602 towards left. As soon as user 104 releases his index finger and makes the gesture as shown in 802 of FIG. 8, 3D hologram 602 stops moving. FIG. 9 again illustrates user 104 joining his index finger and thumb, as shown in 902, to move 3D hologram 602 further towards left in order to touch a wall in the room.

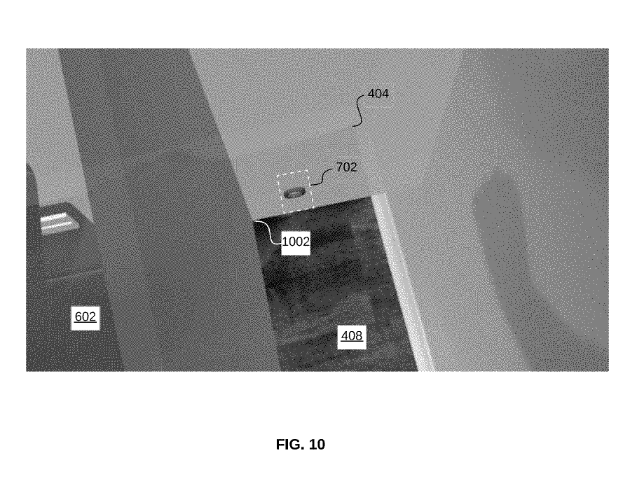

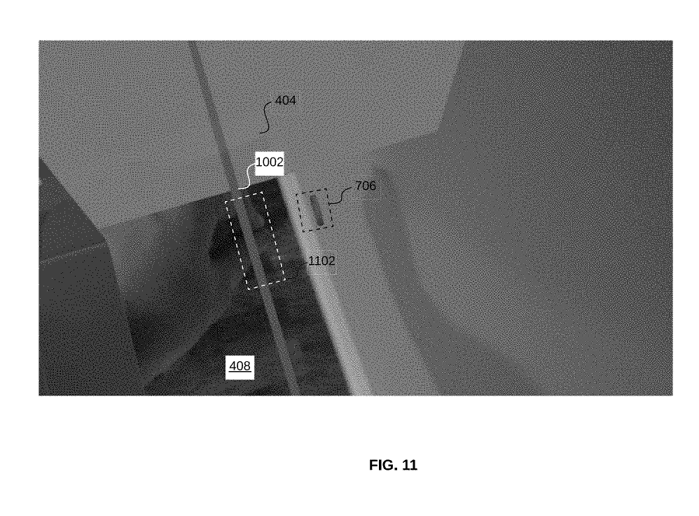

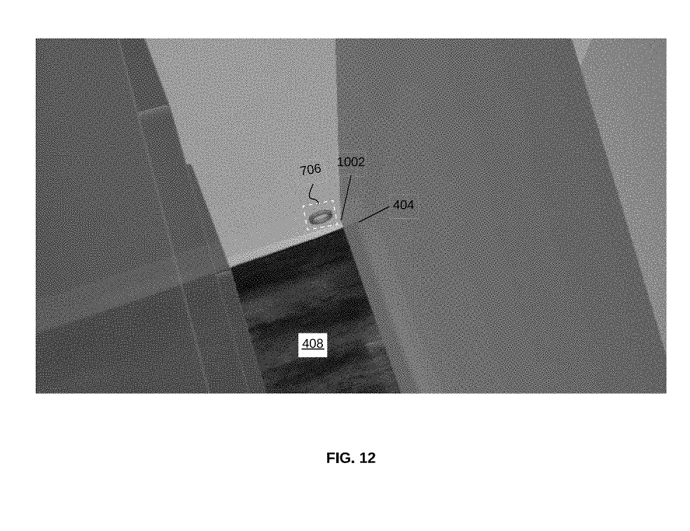

3D hologram 602 is such that a user can walk through it and view the room beyond the rear end of 3D hologram 602. Thus, as depicted in FIG. 10, to make sure that 3D hologram 602 is precisely overlaid, user 104 may walkthrough 3D hologram 602 to check whether a rear end corner 1002 of 3D hologram 602 is aligned with the anchoring point defined at corner 404 of the room. As rear end corner 1002 is offset from the anchoring point, user 104 again activates, via augmented reality device 106, the option to move 3D hologram 602. In response to the activation, cursor 702 appears on display 212 of augmented reality device 106, and user 104 joins his index finger and thumb (as shown in 1102 of FIG. 11) to move 3D hologram 603 and overlay rear end corner 1002 over corner 404 of the room. This movement of 3D hologram 602 is further depicted in FIG. 12, where 3D hologram 602 is precisely overlaid, such that, rear end corner 1002 matched with corner 404, which was defined as the anchoring point, and the edge comprising rear end corner 1002 is aligned with anchoring vector 502 (not shown in FIG. 12).

As will be appreciated by those skilled in the art, the techniques described in the embodiments discussed above provide for an effective and more interactive augmented reality device that enables a user to interact with 3D holograms overlaid in real physical space. The techniques described in the embodiments discussed above immerse a user in a complete mixed reality experience and enable a user to interact with 3D holograms in order to enable precise placement of these holograms in real physical space. As a result, a user is exactly able to visualize how addition of an object within a real physical space or a structural modification in the real physical space would look. The method thus provides a mixed reality experience that is as good as the real experience. The user can thus avoid the situation where the user spends thousands of dollars in implementing these changes in real word and then not being pleased with the end result.

As will be also appreciated, the above described techniques may take the form of computer or controller implemented processes and apparatuses for practicing those methods. The various example methods and/or steps described herein may be performed, at least partially, by one or more processors that can be temporarily configured to perform the relevant operations. Whether temporarily or permanently configured, such processors may constitute processor-implemented modules that can operate to perform one or more operations, steps, or functions. The modules referred to herein may, in some example embodiments, comprise processor-implemented modules.

The disclosure may also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosed embodiments may also be embodied in the form of computer program code or non-transitory signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the embodiments. When implemented on a general-purpose microprocessor, the computer program code segments configure the microprocessor to create specific logic circuits.

A computer program can be written in any form of programming language, including compiled or interpreted languages, and it can be deployed in any form, including as a stand-alone program or as a module, subroutine, or other unit suitable for use in a computing environment. These computer programs can be executed in many exemplary ways, such as an application that is resident in the memory of a device or as a hosted application that is being executed on a server or on multiple computers at one site or distributed across multiple sites and communicating with the device application or browser via any number of standard protocols, such as but not limited to TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Exemplary embodiments are intended to cover execution of method steps on any appropriate specialized or general purpose server, computer device, or processor in any order relative to one another. Some of the steps in the embodiments can be omitted, as desired, and executed in any order. In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

A computer architecture of the embodiments may be a general purpose computer and/or processor or a special purpose computer and/or processor. A computer and/or processor can be used to implement any components of a computer system or the computer-implemented methods of the embodiments. For example, components of a computer system can be implemented on a computer via its hardware, software program, firmware, or a combination thereof. Although individual computers or servers are shown in the embodiments, the computer functions relating to a computer system may be implemented in a distributed fashion on a number of similar platforms, to distribute the processing and/or functional load.

Embodiments are intended to include or otherwise cover methods of rendering virtual objects in real physical space and an augmented reality device 106 disclosed above. The methods of rendering include or otherwise cover processors and computer programs implemented by processors used to design various elements of augmented reality device 106 above. For example, embodiments are intended to cover processors and computer programs used to design or test augmented reality device 106 and the alternative embodiments of augmented reality device 106.

Exemplary embodiments are intended to cover all software or computer programs capable of enabling processors to execute instructions and implement the above operations, designs and determinations. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed above. The disclosure can also be embodied in the form of computer program code containing instructions embodied in non-transitory machine-readable tangible media or any other computer-readable storage medium, wherein, when the computer program code is loaded into and executed by a computer or controller, the computer becomes an apparatus for practicing the embodiments

Embodiments are amenable to a variety of modifications and/or enhancements. For example, although the implementation of various components described above may be embodied in a hardware device, it can also be implemented as a software-only solution, e.g., an installation on an existing server. In addition, systems and their components as disclosed herein can be implemented as a firmware, firmware/software combination, firmware/hardware combination, or a hardware/firmware/software combination.

Some of the disclosed embodiments include or otherwise involve data transfer over a network, such as communicating various inputs over the network. The network may include, for example, one or more of the Internet, Wide Area Networks, Local Area Networks, analog or digital wired and wireless telephone networks (e.g., a PSTN, Integrated Services Digital Network, a cellular network, and Digital Subscriber Line, radio, television, cable, satellite, and/or any other delivery or tunneling mechanism for carrying data. A network may include multiple networks or sub-networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode, and may support voice using or other comparable protocols used for voice data communications. In one implementation, the network includes a cellular telephone network configured to enable exchange of text or SMS messages. The software and instructions used in the embodiments may be embodied in a non-transitory computer readable medium. The term “non-transitory computer readable medium” should be understood to include a single medium or multiple media (e.g., a centralized or distributed database, and/or associated caches and servers) that store the one or more sets of instructions. The term “non-transitory computer readable medium” should also be understood to include any medium that is capable of storing or encoding a set of instructions for execution by any of the processors, servers, or computer systems and that cause the processors, servers, or computer systems to perform any one or more of the methodologies of the embodiments. The term “non-transitory computer readable medium” should further be understood to include, but not be limited to, solid-state memories, and optical media, and magnetic media.

Certain systems, devices, apparatus, applications, methods, processes, or controls are described herein as including a number of modules or component parts. A component part may be a unit of distinct functionality that may be presented in software, hardware, or combinations thereof. When the functionality of a component part is performed in any part through software, the component part includes a non-transitory computer-readable medium. The component parts may be regarded as being communicatively coupled. The embodiments according to the disclosed subject matter may be represented in a variety of different embodiments of which there are many possible permutations.

While the subject matter has been described in detail with reference to exemplary embodiments thereof, it will be apparent to one skilled in the art that various changes can be made, and equivalents employed, without departing from the scope of the invention.

What is claimed is:

1. A method of rendering virtual objects within a real physical space, the method comprising:
capturing, by an augmented reality device, spatial information associated with the real physical space;
defining, by the augmented reality device, an anchoring point and an anchoring vector for placing a virtual object within the real physical space based on the spatial information; and
overlaying, by the augmented reality device, the virtual object on the anchoring point along the anchoring vector, wherein overlaying comprises:
matching a predefined point in the virtual object with the coordinates of the anchoring point; and
aligning a predefined facet of the virtual object with the anchoring vector.

2. The method of claim 1 further comprising interacting, via the augmented reality device, with the virtual objects to refine the overlaying of the virtual object to exactly match the predefined point with the coordinates of the anchoring point and exactly align the predefined facet with the anchoring vector.

3. The method of claim 2, wherein interacting, via the augmented reality device, comprises modifying the orientation of the augmented reality device to move the virtual object within the real physical space.

4. The method of claim 1 further comprising selecting, via the augmented reality device, the virtual object from a list of virtual objects for being overlaid on the anchoring point.

5. The method of claim 1, wherein the virtual object comprises a 3D hologram.

6. An augmented reality device comprising:
a processor,
a plurality of sensors communicatively coupled to the processor;
a display communicatively coupled to the processor;
a memory communicatively coupled to the processor, wherein the memory stores processor instructions, which, on execution, causes the processor to:
capture, via at least one of the plurality of sensors, spatial information associated with the real physical space;
define, via at least one of the plurality of sensors, an anchoring point and an anchoring vector for placing a virtual object within the real physical space based on the spatial information; and
overlay, via the display, the virtual object on the anchoring point along the anchoring vector, wherein the processor overlays the virtual object by:
matching, via at least one of the plurality of sensors, a predefined point in the virtual object with the coordinates of the anchoring point; and
aligning, via at least one of the plurality of sensors, a predefined facet of the virtual object with the anchoring vector.

7. The augmented reality device of claim 6, wherein the processor is further configured to interact, via at least one of the plurality of sensors and the display, with the virtual objects to refine the overlaying of the virtual object to exactly match the predefined point with the coordinates of the anchoring point and exactly align the predefined facet with the anchoring vector.

8. The augmented reality device of claim 6, wherein the processor is further configured to move, via at least one of the plurality of sensors and the display, the virtual object within the real physical space in response to s modification of orientation of the augmented reality device.

9. The augmented reality device of claim 6, wherein processor is further configured to select, via at least one of the plurality of sensors and the display, the virtual object from a list of virtual objects for being overlaid on the anchoring point.

10. A non-transitory computer-readable storage medium having stored thereon, a set of computer-executable instructions for rendering virtual objects within a real physical space, causing a computer comprising one or more processors to perform steps comprising:
capturing, by an augmented reality device, spatial information associated with the real physical space;
defining, by the augmented reality device, an anchoring point and an anchoring vector for placing a virtual object within the real physical space based on the spatial information; and
overlaying, by the augmented reality device, the virtual object on the anchoring point along the anchoring vector, wherein overlaying comprises:
matching a predefined point in the virtual object with the coordinates of the anchoring point; and
aligning a predefined facet of the virtual object with the anchoring vector.
